(19) United States
(12) Patent Application Publication
(10) Pub. No.: US 2012/0301348 A1
(43) Pub. Date: Nov. 29, 2012

(54) NOVEL SOLVENTS FOR METAL ION REDUCTION METHODS, COMPOSITIONS, AND ARTICLES

(75) Inventor: David R. Whitcomb, Woodbury, MN (US)

(73) Assignee: Carestream Health, Inc.

(21) Appl. No.: 13/410,583

(22) Filed: Mar. 2, 2012

Related U.S. Application Data
(60) Provisional application No. 61/488,841, filed on May 23, 2011.

(51) Int. Cl. C22C 9/00; C22C 5/02; B22F 9/18; C22C 5/06; B82Y 30/00; B82Y 40/00

(52) U.S. Cl. 420/469; 75/370; 420/501; 420/507; 977/762; 977/896

(57) ABSTRACT

Methods employing novel solvents are disclosed for making metal nanostructures including metal nanowires. Such methods can be carried out at lower temperatures and higher production rates than those employing ethylene glycol. The products of these methods are useful for electronics applications.

### CROSS REFERENCE TO RELATED APPLICATIONS

This application claims the benefit of U.S. Provisional Application No. 61/488,841, filed May 23, 2011, entitled NOVEL SOLVENTS FOR METAL ION REDUCTION METHODS, COMPOSITIONS, AND ARTICLES, which is incorporated by reference in its entirety.

### BACKGROUND

The general preparation of silver nanowires (10-200 aspect ratio) from silver ions is known. See, for example, Y. Xia, Y. Xiong, B. Lim, S. E. Skrabalak, Angew. Chem. Int. Ed. 2009, 48, 60, and J. Jiu, K. Murai, D. Kim, K. Kim, K. Suganuma, Mat. Chem. & Phys., 2009, 114, 333, both of which are hereby incorporated by reference in their entirety. Such preparations typically employ an aldehyde reducing agent generated by the oxidation of a compound having one or more primary hydroxyl moieties, such as, for example, ethylene glycol, propylene glycol, 1,4-butanediol, and glycerol. Such aldehyde reducing agents have been believed to be responsible for the production of silver metal nanostructures from silver ions.

### SUMMARY

At least some embodiments provide a method comprising providing a composition comprising at least one solvent comprising no primary hydroxyl moieties, where the solvent further comprises at least one ketone or secondary hydroxyl moiety; and reducing at least one first reducible metal ion to at one first metal nanostructure in the presence of the at least one solvent.

In at least some embodiments, the composition further comprises at least one protecting agent, such as, for example, one or more surfactants, one or more acids, or one or more polar polymers. An exemplary protecting agent is polyvinylpyrrolidone.

The at least one first reducible metal ion may, for example, comprise at least one coinage metal ion or at least one ion of an element from IUPAC Group 11, such as, for example, at least one silver ion. In such methods, the at least one first compound may, for example, comprise silver nitrate.

The at least one solvent may, for example, comprise at least two secondary hydroxyl moieties, or at least one ketone comprising at least one secondary hydroxyl moiety. In some cases, the at least one solvent may comprise at least one of 2,3-butanediol, 3-hydroxybutanone, 2,3-butanedione, or (−)-ethyl-L-lactate.

Other embodiments provide the at least one first metal nanostructure produced according to such methods. Still other embodiments provide at least one article comprising the at least one first metal nanostructure produced according such methods. The at least one first metal nanostructure may, for example, comprise one or more nanowires, nanocubes, nanorods, nanopyramids, nanotubes, or nanorings. Or the at least one first metal nanostructure may, for example, comprise at least one metal nanowire having an average diameter of between about 10 nm and about 500 nm. Or the at least one first metal nanostructure may, for example, comprise at least one metal nanowire having an aspect ratio between about 50 and about 10,000.

Yet other embodiments provide at least one metal nanowire with an average diameter of between about 10 nm and about 150 nm, and with an aspect ratio from about 50 to about 10,000. Such a nanowire may, for example, comprise at least one first metal comprising at least one coinage metal, or at least one element of IUPAC Group 11, such as, for example, silver. Yet still other embodiments comprise at least one article comprising such nanowires.

These and other embodiments will be understood by the brief description of figures, figures, description, exemplary embodiments, examples, and claims that follow.

### BRIEF DESCRIPTION OF FIGURES

FIG. 1 shows an optical micrograph of the unpurified silver nanowire product of Example 1.

FIG. 2 shows an optical micrograph of the unpurified silver nanowire product of Example 2.

FIG. 3 shows an optical micrograph of the unpurified silver nanowire product of Example 3.

FIG. 4 shows an scanning electron micrograph of the unpurified silver nanowire product of Example 1.

### DESCRIPTION

All publications, patents, and patent documents referred to in this application are incorporated by reference herein in their entirety, as though individually incorporated by reference.

U.S. Provisional Application No. 61/488,841, filed May 23, 2011, entitled NOVEL SOLVENTS FOR METAL ION REDUCTION METHODS, COMPOSITIONS, AND ARTICLES, is incorporated by reference in its entirety.

### Reducible Metal Ions, IUPAC Group 11 Ions, and Metal Nanostructures

Some embodiments provide methods comprising reducing at least one reducible metal ion to at least one metal nanostructure. A reducible metal ion is a cation that is capable of being reduced to a metal nanostructure under some set of reaction conditions. In such methods, the at least one first reducible metal ion may, for example, comprise at least one coinage metal ion. A coinage metal ion is an ion of one of the coinage metals, which include copper, silver, and gold. Or such a reducible metal ion may, for example, comprise at least one ion of an IUPAC Group 11 element. An exemplary reducible metal ion is a silver cation. Such reducible metal ions may, in some cases, be provided as salts. Silver cations might, for example, be provided as silver nitrate.

### Preparation Methods

A common method of preparing nanostructures, such as, for example, nanowires, is the “polyol” process. Such a process is described in, for example, Angew. Chem. Int. Ed. 2009, 48, 60, Y. Xia, Y. Xiong, B. Lim, S. E. Skrabalak, which is hereby incorporated by reference in its entirety. Such processes typically reduce a metal cation, such as, for example, a silver cation, to the desired metal nanostructure product, such as, for example, a silver nanowire.

Such a reduction may be carried out in a reaction mixture that may, for example, comprise one or more polyols, such as, for example, ethylene glycol (EG), propylene glycol, butanediol, glycerol, sugars, carbohydrates, and the like; one or more protecting agents, such as, for example, polyvinylpyrrolidinone (also known as polyvinylpyrrolidone or PVP), other polar polymers or copolymers, surfactants, acids, and the like; and one or more metal ions. These and other components may be used in such reaction mixtures, as is known in the art. The reduction may, for example, be carried out at one or more temperatures from about 80° C. to about 190° C.

### Novel Solvents

The applicant has discovered that silver ions can be reduced to metallic silver in the presence of a solvent that cannot form an aldehyde reduction agent and that is not itself an aldehyde reduction agent. Such a solvent comprises no primary hydroxyl moieties, but instead comprises at least one ketone or secondary hydroxyl moiety. The at least one solvent may, for example, comprise at least two secondary hydroxyl moieties, or at least one ketone comprising at least one secondary hydroxyl moiety. Exemplary solvents are 2,3-butanediol, 3-hydroxybutanone, 2,3-butanedione, (−)-ethyl-L-lactate.

The applicant has also discovered that silver ion reduction to silver nanowire morphology in such solvents can occur rapidly at a relatively low reaction temperature. For example, such reduction at 125° C. in 2,3-butanediol occurs within 30 min, but requires approximately 4 hrs at this temperature when using ethylene glycol.

### Protecting Agents

Protecting agents are known. Protecting agents are also sometimes referred to by such terms as organic protective agents, protective agents, or capping agents. U.S. Pat. No. 7,922,787 to Wang et al., which is hereby incorporated by reference in its entirety, provides an overview of such references.

For the purpose of this application, protecting agents are compounds that are capable of being absorbed onto a metallic surface, such as, for example, the surface of a metal nanoparticle or metal nanowire. When the metallic surface is that of silver, polyvinylpyrrolidone is commonly used as a protecting agent. However, other compounds are also capable of functioning as protecting agents. For example, other compounds that are capable of interacting electronically with metals, such as compounds containing atoms with one or more free electron pairs, may be able to function as protecting agents. Such atoms include oxygen, sulfur, and nitrogen; they may appear in a variety of functional groups within the protecting agent. Non-limiting examples of such compounds include polyvinyl alcohol, sodium dodecyl sulfate, laurylamine, hydroxypropyl cellulose, and copolymers containing vinyl pyrrolidone moieties. Other non-limiting examples of such compounds include copolymers containing ethylene and ethylene glycol moieties, copolymers containing ethylene and vinyl pyrrolidone moieties, copolymers containing ethylene and vinyl pyridine moieties, copolymers containing vinyl chloride and ethylene glycol moieties, copolymers containing vinyl chloride and vinyl pyrrolidone moieties, copolymers containing vinyl chloride and vinyl pyridine moieties, copolymers containing vinyl acetate and ethylene glycol moieties, copolymers containing vinyl acetate and vinyl pyrrolidone moieties, copolymer containing vinyl acetate and vinyl pyridine moieties, copolymers containing styrene and ethylene glycol moieties, copolymers containing styrene and vinyl pyrrolidone moieties, and copolymer containing styrene and vinyl pyridine moieties. These and other protecting agents will be understood by those skilled in the art.

### Nanostructures and Nanowires

In some embodiments, the metal product formed by such methods is a nanostructure, such as, for example, a one-dimensional nanostructure. Nanostructures are structures having at least one “nanoscale” dimension less than 300 nm, and at least one other dimension being much larger than the nanoscale dimension, such as, for example, at least about 10, or at least about 50, or at least about 100, or at least about 200, or at least about 1000 times larger. Examples of such nanostructures are nanorods, nanowires, nanotubes, nanopyramids, nanoprisms, nanoplates, nanorings, and the like. “One-dimensional” nanostructures have one dimension that is much larger than the other two dimensions, such as, for example, at least about 10 or at least about 100 or at least about 200 or at least about 1000 times larger.

Such one-dimensional nanostructures may, in some cases, comprise nanowires. Nanowires are one-dimensional nanostructures in which the two short dimensions (the thickness dimensions) are less than 300 nm, preferably less than 100 nm, while the third dimension (the length dimension) is greater than 1 micron, preferably greater than 10 microns, and the aspect ratio (ratio of the length dimension to the larger of the two thickness dimensions) is greater than five. Nanowires are being employed as conductors in electronic devices or as elements in optical devices, among other possible uses. Silver nanowires are preferred in some such applications.

Such methods may be used to prepare nanostructures other than nanowires, such as, for example, nanocubes, nanorods, nanopyramids, nanotubes, nanorings, and the like. Nanowires and other nanostructure products may be incorporated into articles, such as, for example, electronic displays, touch screens, portable telephones, cellular telephones, computer displays, laptop computers, tablet computers, point-of-purchase kiosks, music players, televisions, electronic games, electronic book readers, transparent electrodes, solar cells, light emitting diodes, other electronic devices, medical imaging devices, medical imaging media, and the like.

### EXEMPLARY EMBODIMENTS

U.S. Provisional Application No. 61/488,841, filed May 23, 2011, entitled NOVEL SOLVENTS FOR METAL ION REDUCTION METHODS, COMPOSITIONS, AND ARTICLES, which is incorporated by reference in its entirety, disclosed the following 24 non-limiting exemplary embodiments:

A. A method comprising:

providing a composition comprising:
at least one first compound comprising at least one first reducible metal ion; and
at least one solvent comprising no primary hydroxyl moieties, said solvent further comprising at least one ketone or secondary hydroxyl moiety; and

reducing the at least one first reducible metal ion to at least one first metal.

B. The method of embodiment A, wherein the composition further comprises at least one protecting agent.
C. The method of embodiment B, wherein the at least one protecting agent comprises at least one of: one or more surfactants, one or more acids, or one or more polar polymers.
D. The method of embodiment B, wherein the at least one protecting agent comprises polyvinylpyrrolidinone.
E. The method of embodiment B, further comprising inerting the at least one protecting agent.
F. The method of embodiment A, wherein the at least one first reducible metal ion comprises at least one coinage metal ion.
G. The method of embodiment A, wherein the at least one first reducible metal ion comprises at least one ion of an element from IUPAC Group 11.
H. The method of embodiment A, wherein the at least one first reducible metal ion comprises at least one ion of silver.
J. The method of embodiment A, wherein the at least one first compound comprises silver nitrate.
K. The method of embodiment A, wherein the at least one solvent comprises at least two secondary hydroxyl moieties.
L. The method of embodiment A, wherein the at least one solvent comprises at least one ketone comprising at least one secondary hydroxyl moiety.
M. The method of embodiment A, wherein the at least one solvent comprises at least one of: 2,3-butanediol, 3-hydroxybutanone, or 2,3-butanedione.
N. The method of embodiment A, wherein the metal ion reduction is carried out at one or more temperatures from about 25° C. to about 190° C.
P. The method of embodiment A, further comprising inerting one or more of: the composition, the at least one compound comprising at least one first reducible metal ion, or the at least one solvent.
R. The at least one first metal produced according to the method of embodiment A.
S. At least one article comprising the at least one first metal produced according to the method of embodiment A.
T. The at least one article of embodiment S, wherein the at least one first metal comprises one or more nanowires, nanocubes, nanorods, nanopyramids, or nanotubes.
U. The at least one article of embodiment S, wherein the at least one first metal comprises at least one object having an average diameter of between about 10 nm and about 500 nm.

V. The at least one article of embodiment S, wherein the at least one first metal comprises at least one object having an aspect ratio from about 50 to about 10,000.

W. At least one metal nanowire with an average diameter of between about 10 nm and about 150 nm, and with an aspect ratio from about 50 to about 10,000.
X. The nanowire of embodiment W, wherein the at least one metal comprises at least one coinage metal.
Y. The nanowire of embodiment W, wherein the at least one metal comprises at least one element of IUPAC Group 11.
Z. The nanowire of embodiment W, wherein the at least one metal comprises silver.
AA. At least one article comprising the at least one metal nanowire of embodiment W.

### EXAMPLES

### Example 1

Into a 500 mL reaction flask was added 230 mL 2,3-butanediol and 0.8 g of a 22 mM solution of FeCl₂ in 2,3-butanediol. This solution was stripped of at least some dissolved gases by bubbling N₂ into the solution for at least 2 hrs using a TEFLON® fluoropolymer tube at room temperature with mechanical stirring while at 100 rpm. (This operation will be referred to as “degassing” in the sequel.) Stock solutions of 0.25 M AgNO₃ in 2,3-butanediol and 0.84 M polyvinylpyrrolidinone (PVP) in 2,3-butanediol were also degassed by bubbling N₂ into the solutions at room temperature. Two syringes were loaded with 20 mL each of the AgNO₃ and PVP solutions. The reaction mixture was heated to 145° C. over 45 min under 0.5 mL/min N₂ blanketing. The AgNO₃ and PVP solutions were then added at a constant rate over 20 minutes via 12 gauge TEFLON® fluoropolymer syringe needles. Excellent silver nanowires were produced even before the addition of the AgNO₃ and PVP solutions was complete.

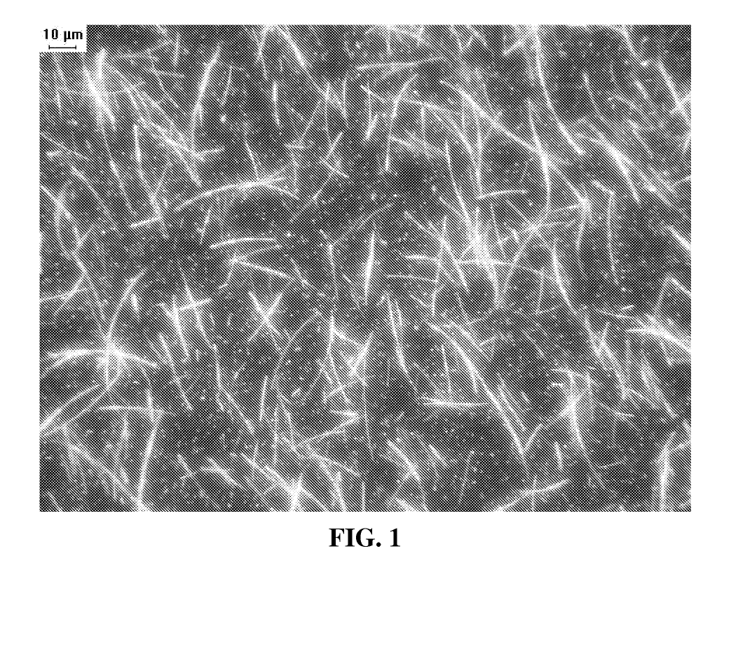

An optical micrograph of the unpurified silver nanowire product is shown in FIG. 1. The average length and diameter of the nanowires were calculated by measurement of at least 100 nanowires and found to be 16.8±8.5 μm and 71.8±26.6 nm, respectively.

### Example 2

The procedure of Example 1 was repeated, but using a reaction temperature of 125° C. instead of 145° C. Excellent silver nanowires were produced within 30 min.

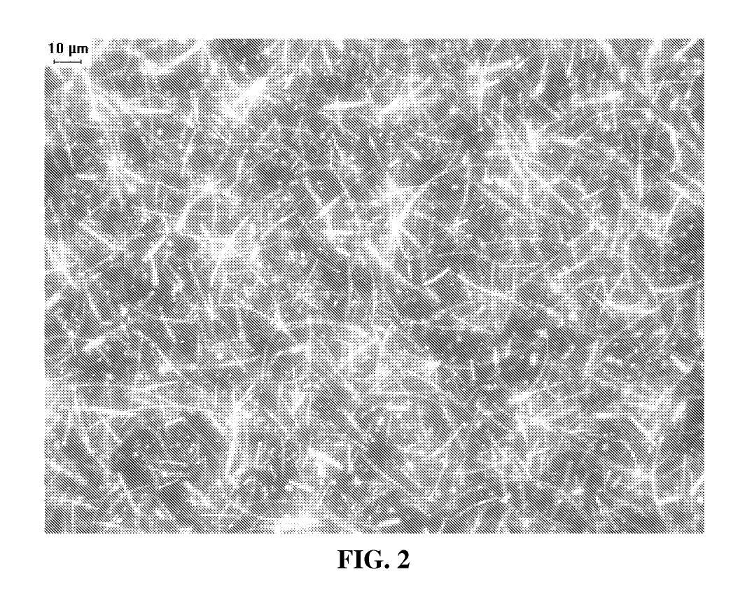

An optical micrograph of the unpurified silver nanowire product is shown in FIG. 2. The average length and diameter of the nanowires were calculated by measurement of at least 100 nanowires and found to be 16.5±9.4 μm and 64.6±28.7 nm, respectively.

### Example 3

Into a 500 mL reaction flask was added 200 mL of (−)-ethyl-L-lactate (EL) and 1.2 g of 3.0 mM SnCl₂ in EL. This solution was degassed 60 min using a TEFLON® fluoropolymer tube. The tube was partially retracted to provide nitrogen headspace blanketing at 0.5 L/min. Stock solutions of 0.18 M AgNO₃ in EL and 0.56 M polyvinylpyrrolidinone (PVP) in EL were also degassed by bubbling N₂ into the solutions at room temperature. Two syringes were loaded with 30 mL each of the AgNO₃ and PVP solutions. The reaction mixture was heated to 145° C. under 0.5 mL/min N₂ blanketing. The AgNO₃ and PVP solutions were then added at a constant rate of 0.8 mL/min via 12 gauge TEFLON® fluoropolymer syringe needles.

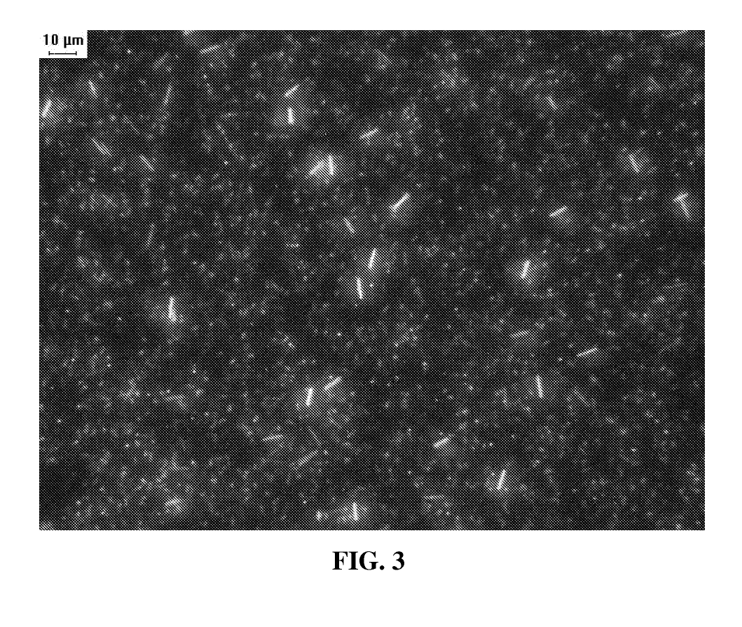

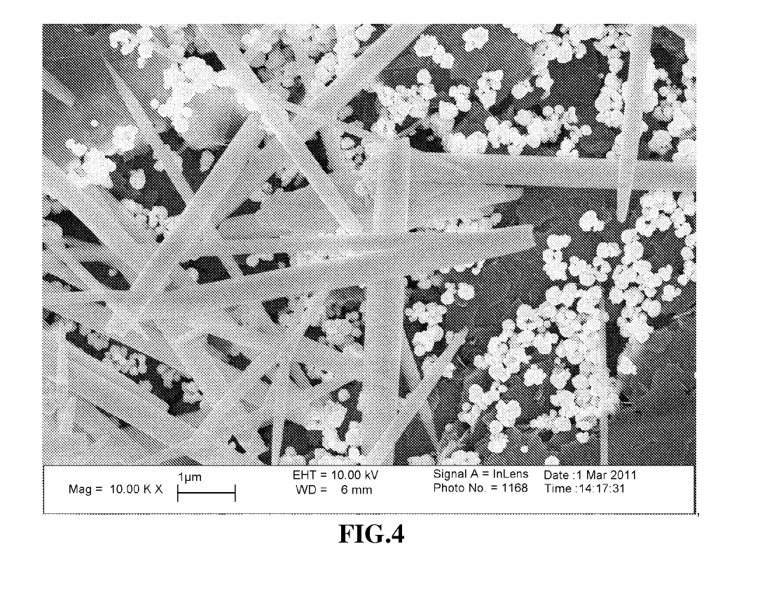

FIG. 3 shows an optical micrograph of the silver nanowire product. FIG. 4 shows a scanning electron micrograph of the silver nanowire product. The average length and diameter of the nanowires were calculated by measurement of at least 100 nanowires and found to be 7.6±1.9 μm and 350±152 nm, respectively.

### Example 4 (Comparative)

Into a 100 mL reaction flask was added 30 mL diethyleneglycol dimethylether (DEGME), 30 g of pinacol, 0.35 g of 22 mM SnCl₂ in pinacol/DEGDME, and 0.44 g polyvinylpyrrolidone. This solution was degassed with argon for more than two hours using a glass pipette. The pipette was partially retracted to provide argon headspace blanketing at 0.5 L/min. A stock AgNO₃ solution was also degassed using argon. A syringe was loaded with 10 mL of the AgNO₃ solution. The reaction mixture was heated to 143° C. under argon blanketing. The AgNO₃ solution was then added at a constant rate over 25 min via a 20 gauge TEFLON® fluoropolymer syringe needle. After 60 min, no nanowires were present, but only nanoparticles.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed:

1. A method comprising:
providing a first composition comprising at least one solvent comprising no primary hydroxyl moieties, said solvent further comprising at least one ketone or secondary hydroxyl moiety; and
reducing at least one reducible metal ion to at least one metal nanostructure in the presence of the at least one solvent.

2. The method according to claim 1, wherein the at least one first composition further comprises at least one protecting agent.

3. The method according to claim 1, wherein the at least one first composition further comprises polyvinylpyrrolidone.

4. The method according to claim 1, wherein the at least one reducible metal ion comprises at least one of coinage metal ion or ion of an element from IUPAC Group 11.

5. The method according to claim 1, wherein the at least one reducible metal ion comprises at least one silver ion.

6. The method according to claim 1, wherein the at least one solvent comprises at least two secondary hydroxyl moieties, or the at least one solvent comprises at least one ketone comprising at least one secondary hydroxyl moiety.

7. The method according to claim 1, wherein the at least one solvent comprises at least one of: 2,3-butanediol, 3-hydroxybutanone, 2,3-butanedione, or (−)-ethyl-L-lactate.

8. The at least one metal nanostructure produced according to the method of claim 1.

9. The at least one metal nanostructure according to claim 8, comprising at least one metal nanowire.

10. The at least one metal nanostructure according to claim 8, comprising at least one metal nanowire comprising an aspect ratio between about 50 and about 10,000.
